(19) United States
(12) Patent Application Publication
(10) Pub. No.: US 2024/0204175 A1
(43) Pub. Date: Jun. 20, 2024

(54) NEGATIVE ELECTRODE FOR LITHIUM SECONDARY BATTERY AND LITHIUM SECONDARY BATTERY COMPRISING THE SAME

(71) Applicant: SK ON CO., LTD., Seoul (KR)

(72) Inventors: Hyo Mi KIM, Daejeon (KR); Hwan Ho JANG, Daejeon (KR); Da Bin CHUNG, Daejeon (KR); Moon Sung KIM, Daejeon (KR); Sang Baek RYU, Daejeon (KR); Da Hye PARK, Daejeon (KR); Sang In BANG, Daejeon (KR); Seung Hyun YOOK, Daejeon (KR); Jun Hee HAN, Daejeon (KR)

(21) Appl. No.: 18/538,709

(22) Filed: Dec. 13, 2023

(30) Foreign Application Priority Data
Dec. 15, 2022 (KR) 10-2022-0175660

(51) Int. Cl. H01M 4/36; H01M 4/04; H01M 4/485; H01M 4/583; H01M 4/62; H01M 10/052

(52) U.S. Cl. CPC H01M 4/366; H01M 4/0404; H01M 4/485; H01M 4/583; H01M 4/625; H01M 10/052; H01M 2004/021

(57) ABSTRACT

Negative electrodes for lithium secondary batteries and lithium secondary batteries including the negative electrodes are disclosed. In some implementations, a negative electrode for a secondary battery includes a negative electrode current collector, a first negative electrode mixture layer including a first silicon-based negative electrode active material and disposed on at least one surface of the negative electrode current collector, and a second negative electrode mixture layer including a second silicon-based negative electrode active material and disposed on the first negative electrode mixture layer, wherein the second silicon-based negative electrode active material is SiOx (0≤x<2) doped with a metal element.

### CROSS-REFERENCE TO RELATED APPLICATION(S)

This patent document claims the priority and benefits of Korean Patent Application No. 10-2022-0175660 filed on Dec. 15, 2022, the disclosure of which is incorporated herein by reference in its entirety.

### TECHNICAL FIELD

The technology and implementations disclosed in this patent document generally relate to a negative electrode for a lithium secondary battery and a lithium secondary battery including the same.

### BACKGROUND

As interest in environmental issues has recently increased, exhaust gases discharged from vehicles that use fossil fuels, such as gasoline or diesel, have been identified as one of the main causes of air pollution, and many studies have been conducted on electric vehicles (EVs) and hybrid electric vehicles (HEVs) that can replace vehicles that use fossil fuels.

Lithium secondary batteries having a high discharge voltage and excellent output stability are mainly used as power sources for electric vehicles (EVs) and hybrid electric vehicles (HEVs). In addition, as the need for high-energy secondary batteries having a high energy density increases, development and research on high-capacity negative electrodes are actively being conducted.

### SUMMARY

The disclosed technology may be implemented in some exemplary embodiments to provide a negative electrode capable of suppressing an increase in resistance by suppressing a side reaction with an electrolyte resulting from the use of a silicon-based negative electrode active material and a secondary battery including the same.

The disclosed technology may also be implemented in some exemplary embodiments to provide a negative electrode including a silicon-based negative electrode active material, capable of suppressing short circuits and active material cracks caused by an increase in volume contraction and expansion during charging and discharging, and a lithium secondary battery including the same.

In some exemplary embodiments of the disclosed technology, a negative electrode for a secondary battery includes: a negative electrode current collector; a first negative electrode mixture layer including a first silicon-based negative electrode active material on at least one surface of the negative electrode current collector; and a second negative electrode mixture layer including a second silicon-based negative electrode active material on the first negative electrode mixture layer, wherein the second silicon-based negative electrode active material is SiOx (0≤x<2) doped with a metal element. In some implementations, the negative electrode current collector may include a conductive material layer configured to serve as a negative electrode current collector.

The metal element may be at least one selected from the group consisting of Mg, Li, Ca, Al, Fe, Ti, and V.

The content of the second silicon-based negative electrode active material having a particle size of 2.5 μm or less may be less than 5 volume % of a total content of the second silicon-based negative electrode active material.

The first silicon-based negative electrode active material may be SiOx coated with carbon.

The content of the first silicon-based negative electrode active material having a particle size of 2.5 μm or less may be 1 volume % or more and less than 15 volume % of the total content of the first silicon-based negative electrode active material.

The content of the second silicon-based negative electrode active material may be greater than the content of the first silicon-based negative electrode active material with respect to a total weight of the first negative electrode mixture layer and the second negative electrode mixture layer.

In the first negative electrode mixture layer, the content of the first silicon-based negative electrode active material may be 2 to 6 wt %.

In the second negative electrode mixture layer, the content of the second silicon-based negative electrode active material may be 7 to 30 wt %.

The first negative electrode mixture layer and the second negative electrode mixture layer may further include a graphite-based active material.

The first negative electrode mixture layer and the second negative electrode mixture layer may further include a conductive agent.

The second negative electrode mixture layer may include at least one selected from the group consisting of single-walled carbon nanotube (SWCNT), thin-walled carbon nanotube (TWCNT), and multi-walled carbon nanotube (MWCNT) as a conductive agent.

In some exemplary embodiments of the disclosed technology, a lithium secondary battery includes: the at least one negative electrode described above, a positive electrode, and a separator interposed between the negative electrode and the positive electrode.

### BRIEF DESCRIPTION OF DRAWINGS

Certain aspects, features, and advantages of the disclosed technology are illustrated by the following detailed description with reference to the accompanying drawings.

FIG. 1 is a view schematically illustrating a cross-section of an example of a negative electrode based on some embodiments of the disclosed technology.

### DETAILED DESCRIPTION

Section headings are used in the present document only for ease of understanding and do not limit scope of the embodiments to the section in which they are described.

The disclosed technology can be implemented to construct a lithium secondary battery that includes one negative electrode, a positive electrode, and a separator interposed between the negative electrode and the positive electrode. More specifically, the disclosed technology may be implemented in some exemplary embodiments to provide a negative electrode including a silicon-based negative electrode active material. Some embodiments of the disclosed technology will be described in detail with reference to the accompanying drawings.

In some implementations, silicon-based negative electrode active materials with a higher discharge capacity than graphite are being applied to negative electrodes for secondary batteries in order to realize secondary batteries with high capacity and high energy density. As an example of such silicon-based materials, a mixture of silicon oxide and carbon that exhibits a high capacity of 30000 mA/g may be used.

However, silicon-based active materials, such as silicon oxide, may increase resistance due to side reactions with electrolyte, and the amount of volumetric contraction and expansion may be very large during charging and discharging. Accordingly, battery life and rapid charging characteristics may be reduced due to short circuits or cracks in the active materials.

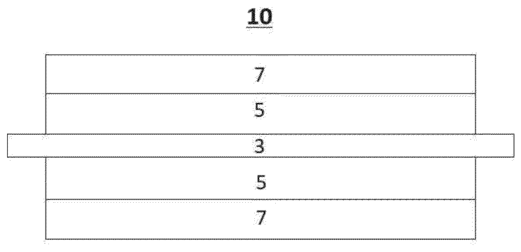

FIG. 1 is a view schematically illustrating a cross-section of an example of a negative electrode based on some embodiments of the disclosed technology. In some embodiments, a negative electrode 10 includes a first negative electrode mixture layer 5 formed on one or both surfaces of a negative electrode current collector 3 and a second negative electrode mixture layer 7 formed on the first negative electrode mixture layer 5. In some implementations, the negative electrode 10 may be configured to absorb and release electrons. In some implementations, the negative electrode current collector 3 may serve as a conductive substrate on which a negative electrode active material is deposited, allowing for the flow of electrons during the charging and discharging process.

The negative electrode current collector 3 is commonly used in the manufacture of negative electrodes of secondary batteries. In some implementations, the negative electrode current collector 3 may include any material as long as it has conductivity without causing chemical changes in the battery. For example, the negative electrode current collector may include at least one of copper, stainless steel, aluminum, nickel, titanium, fired carbon, copper surface-treated with carbon, nickel, titanium or silver, stainless steel surface-treated with carbon, nickel, titanium or silver, or an aluminum-cadmium alloy. In some embodiments, the negative electrode current collector may be formed to have fine irregularities on its surface, enhancing bonding strength of the negative electrode active material, and various forms, such as films, sheets, foils, nets, porous bodies, foams, and nonwoven fabrics may be used.

In some embodiments, a negative electrode mixture layer (e.g., 5 and 7 in FIG. 1) is part of the negative electrode current collector 3. For example, the negative electrode mixture layer is a surface layer of the negative electrode current collector 3 or is included in the surface layer of the negative electrode current collector 3. As shown in FIG. 1, the negative electrode mixture layer includes the first negative electrode mixture layer 5 located on the negative electrode current collector 3 and the second negative electrode mixture layer 7 located on the first negative electrode mixture layer 5.

In some embodiments, the negative electrode mixture layer may further include one or more additional negative electrode mixture layers on or below the first negative electrode mixture layer 5 and/or on or below the second negative electrode mixture layer 7. The additional negative electrode mixture layer is not particularly limited, and may be, for example, one layer or two or more layers.

The first negative electrode mixture layer 5 and the second negative electrode mixture layer 7 include a silicon-based negative electrode active material. In some embodiments of in the disclosed technology, the silicon-based negative electrode active material may include any material that may be generally used as a negative electrode active material. In one example, the negative electrode active material may include at least one selected from the group consisting of SiOx (0≤x<2), a Si—C composite, and a Si—Y alloy. Here, Y is an element selected from the group consisting of alkali metals, alkaline earth metals, transition metals, Group 13 elements, Group 14 elements, rare earth elements, and combinations thereof.

The first silicon-based negative electrode active material included in the first negative electrode mixture layer 5 may include carbon. In some embodiments, the term “first silicon-based negative electrode active material” may be used to indicate the silicon-based negative electrode active material included in the first negative electrode mixture layer 5. In one example, the silicon-based negative electrode active material including carbon may be a carbon-coated silicon-based negative electrode active material. In another example, the silicon-based negative electrode active material including carbon may be a composite of silicon and carbon. Here, in the silicon-based negative electrode active material including carbon, the content of carbon may be 2 to 5 wt % but is not limited thereto.

In some embodiments, the carbon-coated silicon-based negative electrode active material may include a carbon coating layer on the surface of the silicon-based negative electrode active material. In one example, the carbon-coated silicon-based negative electrode active material may be a carbon-coated SiOx. In one example, the carbon coating layer may be formed on a portion of the silicon-based negative electrode active material. In another example, the carbon coating layer may be formed on the entire surface of the silicon-based negative electrode active material. In addition, the carbon coating layer may have, for example, an average thickness of 5 to 50 nm, but is not limited thereto.

As described above, when the negative electrode active material of the first negative electrode mixture layer 5 includes a silicon-based negative electrode active material, such as a carbon-coated silicon-based negative electrode active material, it is possible to reduce, minimize or prevent a deterioration of high-temperature lifespan characteristics in the case of using an Mg-doped silicon-based negative electrode active material as the negative electrode active material of the second negative electrode mixture layer 7.

In the first negative electrode mixture layer 5, the amount of the first silicon-based negative electrode active material may be 2 to 6 wt %. If the amount of the first silicon-based negative electrode active material is less than 2 wt %, an excessive amount of the second silicon-based negative electrode active material may be disposed in an upper layer when the same energy density is realized. In this case, excessive side reactions between the electrolyte and the second silicon-based negative electrode active material may occur to degrade battery performance. In some implementations, if the amount of the first silicon-based negative electrode active material exceeds 6 wt %, the first negative electrode mixture layer may be detached from the negative electrode current collector 3 due to a short circuit in the battery that occurs due to volume contraction and expansion of the first silicon-based active material.

The first silicon-based negative electrode active material included in the first negative electrode mixture layer 5 may have an average particle size (D50) of 4 to 10 μm, more specifically 4 to 7 μm, or 5 to 6 μm, but the disclosed technology is not limited thereto.

The first silicon-based negative electrode active material included in the first negative electrode mixture layer 5 may include fine powder. The first silicon-based negative electrode active material of fine powder has a particle size of 2.5 μm or less. If the particle size of the first silicon-based negative electrode active material of fine powder exceeds 2.5 μm, the first silicon-based negative electrode active material of fine powder itself may contract and expand significantly when charging and discharging lithium ions, and as charging and discharging are repeated, the binding force between particles may decrease, deteriorating cycle characteristics.

Since the first negative electrode mixture layer 5 is a region that has relatively little contact with the electrolyte, excessive side reactions with the electrolyte may be prevented even if the first negative electrode mixture layer 5 includes the first silicon-based negative electrode active material of fine powder. In addition, by including the first silicon-based negative electrode active material of fine powder, a contact area between the negative electrode active materials of the first negative electrode mixture layer 5 and between the negative electrode active material and the negative electrode current collector 3 may increase, thereby mitigating short-circuits between negative active materials that may occur due to contraction and expansion of the silicon-based negative active materials during the battery charging and discharging process.

Specifically, the first silicon-based negative electrode active material of fine powder included in the first negative electrode mixture layer 5 may be 1 volume % or more and less than 15 volume % of the volume of the first silicon-based negative electrode active material included in the first negative electrode mixture layer 5.

The second negative electrode mixture layer 7 includes a silicon-based negative electrode active material different from that of the first negative electrode mixture layer 5. Specifically, the second negative electrode mixture layer 7 includes a silicon-based negative electrode active material doped with a predetermined element, as a second silicon-based negative electrode active material.

The silicon-based negative electrode active material (the second silicon-based negative electrode active material) included in the second negative electrode mixture layer 7 may be a silicon-based negative electrode active material doped with at least one metal selected from the group consisting of Mg, Li, Ca, Al, Fe, Ti, and V.

In addition, the silicon-based negative electrode active material doped with the above metal may include a compound including at least one metal among the above metals. For example, the silicon-based negative electrode active material doped with the above metal may include SiOx including a lithium compound or a magnesium compound, and may be SiOx pretreated with lithium or magnesium, and more specifically, it may include lithium silicate or magnesium silicate.

When the second negative electrode mixture layer 7 includes the silicon-based negative electrode active material doped with the metal as described above, contraction and expansion of the silicon-based negative electrode active material may be suppressed by the doping element and cracks and short circuits occurring due to stress may be suppressed, and accordingly room temperature lifespan characteristics and rapid charging characteristics of a negative electrode including a silicon-based negative electrode active material may be improved.

The content of the second silicon-based negative electrode active material included in the second negative electrode mixture layer 7 may be 7 to 30 wt %. If the content of the second silicon-based negative electrode active material is less than 7 wt %, the content of the carbon-based negative electrode active material may increase compared to the silicon-based negative electrode active material, thereby lowering the initial efficiency and making it difficult to implement a high energy density cell. If the content of the second silicon-based negative electrode active material exceeds 30 wt %, a short circuit may occur in the battery due to volume expansion resulting from the charging and discharging, and cell performance may be deteriorated due to a side reaction between the excessive amount of the silicon-based negative electrode active material and the electrolyte.

The second negative electrode mixture layer 7 may be located on the surface of the entire negative electrode mixture layer and may easily come into contact with the electrolyte, and therefore, side reactions may easily occur between the second silicon-based negative electrode active material present in the second negative electrode mixture layer 7 and the electrolyte, causing an increase in resistance and high contraction and expansion characteristics during charging and discharging. These side reactions and contraction/expansion characteristics tend to increase as the particle size of the silicon-based negative electrode active material decreases. Therefore, as the second silicon-based negative active material included in the second negative electrode mixture layer 7 has a smaller content of fine powder having a particle size of 2.5 μm or less, side reactions with the electrolyte may be prevented and the contraction/expansion characteristics may be suppressed.

In some implementations, the second silicon-based negative electrode active material included in the second negative electrode mixture layer 7 is preferable as the content of the silicon-based negative electrode active material of fine powder having a particle size of 2.5 μm or less is reduced, but without being limited thereto, the content of the silicon-based negative electrode active material of fine powder may be less than 5 volume %.

An average particle size of the second silicon-based negative electrode active material included in the second negative electrode mixture layer 7 may be greater than an average particle size of the first silicon-based negative electrode active material included in the first negative electrode mixture layer 5. In this manner, by using a silicon-based negative electrode active material having a large average particle size with respect to the silicon-based negative electrode active material included in the second negative electrode mixture layer 7, side reactions with the electrolyte may be suppressed, and by using a silicon-based negative electrode active material having an average particle size included in the first negative electrode mixture layer 5, the contact area between the negative electrode active materials and between the negative electrode active material and the negative electrode current collector 3 may be widened to reduce or minimize short circuits.

In some implementations, the average particle size of the second silicon-based negative electrode active material included in the second negative electrode mixture layer 7 may be 4 to 8 μm, and the average particle size of the first silicon-based negative electrode active material included in the first negative electrode mixture layer 5 may be smaller than the average particle size of the second silicon-based negative electrode active material and may be 3 to 7 μm, but the disclosed technology is not limited thereto.

In some embodiments of the disclosed technology, the content of the second silicon-based negative electrode active material included in the second negative electrode mixture layer 7 may be greater than the content of the first silicon-based negative electrode active material included in the first negative electrode mixture layer 5.

Since a diffusion rate of lithium ions in the silicon-based negative electrode active material is slower than that of the graphite-based negative electrode active material, lifespan characteristics may be improved by placing an excessive amount of the silicon-based active material on the upper layer of the negative electrode (e.g., the second negative electrode mixture layer 7, which is in contact with the electrolyte). In contrast, if an excessive amount of silicon-based negative electrode active material is located in the lower layer (e.g., the first negative electrode mixture layer 5), lifespan characteristics may deteriorate due to detachment between the negative electrode current collector 3 and the first negative electrode mixture layer 5 resulting from contraction and expansion of the silicon-based negative electrode active material in the process of charging and discharging the battery.

As the second negative electrode mixture layer 7, which is an upper layer, becomes thicker than the first negative electrode mixture layer 5, lifespan performance of the battery may be more advantageously improved. Therefore, the first negative electrode mixture layer 5 and the second negative electrode mixture layer 7 may have a thickness ratio of 2 to 5:5 to 8, but the disclosed technology is not limited thereto.

The first and second negative electrode mixture layers 5 and 7 may each independently further include an additional silicon-based negative electrode active material in addition to the silicon-based negative electrode active material described above. In some implementations, the first negative electrode mixture layer 5 may further include general silicon-based negative electrode active materials in addition to the carbon-coated silicon-based negative electrode active material, and the second negative electrode mixture layer 7 may further include general silicon-based negative electrode active materials other than the doped silicon-based negative electrode active material.

The first and second negative electrode mixture layers 5 and 7 may each independently include a carbon-based negative electrode active material as a negative electrode active material. The carbon-based negative electrode active material is not particularly limited, but may be, for example, at least one selected from the group consisting of artificial graphite, natural graphite, and graphitized mesocarbon microbeads, and more specifically, artificial graphite may be used, and a mixture of artificial graphite and natural graphite may be used.

The carbon-based negative electrode active material included in the first and second negative electrode mixture layers 5 and 7 is not limited thereto, but may be, for example, 30 to 95 wt % of the total weight of each of the negative electrode mixture layers 5 and 7. The content of the carbon-based negative electrode active material may be the same as or different from each other with respect to the first and second negative electrode mixture layers 5 and 7, and may be independent of each other.

In addition, each of the first and second negative electrode mixture layers 5 and 7 may independently include a binder for bonding between negative electrode active materials. As the binder, at least one selected from the group consisting of a rubber-based binder and a water-soluble polymer-based binder may be used.

In some implementations, the rubber-based binder is not soluble in aqueous solvents such as water, but has water dispersibility to be smoothly dispersed in aqueous solvents. For example, the rubber-based binder may include at least one selected from styrene butadiene rubber (SBR), hydrogenated nitrile butadiene rubber (HNBR), acrylonitrile butadiene rubber, acrylic rubber, butyl rubber, and fluoro rubber. Specifically, the rubber-based binder may include at least one selected from the group consisting of styrene butadiene rubber and hydrogenated nitrile butadiene rubber, more specifically, styrene butadiene rubber, because it is easy to disperse and has excellent phase stability.

In addition, the water-soluble polymer-based binder is soluble in aqueous solvents, such as water, and may include polyvinyl alcohol (PVA), polyacrylic acid (PAA), polyethylene glycol (PEG), and polyacrylonitrile (PAN), polyacrylamide (PAM), and carboxylmethyl cellulose (CMC).

Each of the rubber-based binder and the water-soluble polymer-based binder is not limited thereto, but may be included in an amount of 0.5 to 3 wt % based on the total weight of each of the first and second negative electrode mixture layers 5 and 7.

Furthermore, the first and second negative electrode mixture layers 5 and 7 may each independently include a conductive agent to improve conductivity. When the conductive agent is included, for example, one or more selected from the group consisting of graphite, carbon black, CNT, metal powder, and conductive oxide may be used, but is not particularly limited.

In some implementations, different types of conductive agents may be used in the first negative electrode mixture layer 5 and the second negative electrode mixture layer 7. For example, the first negative electrode mixture layer 5 may use at least one conductive agent selected from the group consisting of MWCNT, SWCNT, TWCNT, graphite, carbon black, metal powder, and conductive oxide, and the second negative electrode mixture layer 7 including a large amount of silicon-based active materials may use at least one conductive agent selected from the group consisting of SWCNT, MWCNT, and TWCNT in order to improve the effect of preventing peeling due to contraction and expansion of the silicon-based active material during charging and discharging.

The conductive agent may be independently included in an amount of 0.1 to 3 wt % based on the total weight of each of the negative electrode mixture layers 5 and 7.

As described above, in some embodiments of the disclosed technology, a silicon-based negative electrode active material doped with an alkali metal or alkaline earth metal element, and in some implementations, without fine powder, may be applied to the second negative electrode mixture layer 7, which is the upper layer of the negative electrode mixture layer. In addition, a silicon-based negative electrode active material, and in some implementations, a carbon-coated silicon-based negative electrode active material, more specifically, including fine powder, may be applied to the first negative electrode mixture layer 5, which is the lower layer. In this way, the disclosed technology can be implemented in some embodiments to provide the negative electrode that can control side reactions with the electrolyte, improve high-temperature characteristics, and reduce or minimize short circuits.

### EXAMPLE

Hereinafter, some embodiments of the disclosed technology will be described in more detail with examples. The following examples are provided as examples of some embodiments of the disclosed technology, and the disclosed technology is not limited to the examples below.

### Example 1 and Comparative Examples 1 to 6

A first negative electrode slurry was prepared by mixing graphite as a carbon-based active material, A1, A2, B1, or B2 as a silicon-based active material, MWCNT as a conductive agent, and SBR and CMC as a binder with water as a solvent in the amounts shown in Table 1.

In addition, a second negative electrode slurry was prepared by mixing graphite as a carbon-based active material, A1, A2, B1, or B2 as a silicon-based active material, SWCNT as a conductive agent, and SBR and CMC as a binder with water as a solvent in the amounts shown in Table 1.

At this time, A1, A2, B1 and B2 are respectively as follows.

A1: SiOx coated with carbon, content of fine powder having a particle size less than 2.5 μm=3 volume %

A2: SiOx coated with carbon, content of fine powder having a particle size less than 2.5 μm=10 volume %

B1: Mg-doped SiOx, content of fine powder having a particle size less than 2.5 μm=3 volume %

B2: Mg-doped SiOx, content of fine powder having a particle size less than 2.5 μm=10 volume %

TABLE 1

| | | carbon-based | | silicon-based | | conductive | | | |
|---|---|---|---|---|---|---|---|---|---|
| | | active material | | active material | | additive | | SBR | CMC |
| | | kind | wt % | kind | wt % | kind | wt % | (wt %) | (wt %) |
| Example 1 | first | graphite | 89.9 | A2 | 6 | MWCNT | 0.5 | 2.4 | 1.2 |
| | mixture | | | | | | | | |
| | layer | | | | | | | | |
| | second | | 83.1 | B1 | 15 | SWCNT | 0.1 | 0.6 | 1.2 |
| | mixture | | | | | | | | |
| | layer | | | | | | | | |
| Comparative | first | graphite | 89.9 | A2 | 6 | MWCNT | 0.5 | 2.4 | 1.2 |
| Example 1 | mixture | | | | | | | | |
| | layer | | | | | | | | |
| | second | | 83.1 | A1 | 15 | SWCNT | 0.1 | 0.6 | 1.2 |
| | mixture | | | | | | | | |
| | layer | | | | | | | | |
| Comparative | first | graphite | 89.9 | A2 | 6 | MWCNT | 0.5 | 2.4 | 1.2 |
| Example 2 | mixture | | | | | | | | |
| | layer | | | | | | | | |
| | second | | 83.1 | B2 | 15 | SWCNT | 0.1 | 0.6 | 1.2 |
| | mixture | | | | | | | | |
| | layer | | | | | | | | |
| Comparative | first | graphite | 89.9 | B2 | 6 | MWCNT | 0.5 | 2.4 | 1.2 |
| Example 3 | mixture | | | | | | | | |
| | layer | | | | | | | | |
| | second | | 83.1 | B1 | 15 | SWCNT | 0.1 | 0.6 | 1.2 |
| | mixture | | | | | | | | |
| | layer | | | | | | | | |
| Comparative | first | graphite | 89.9 | A1 | 6 | MWCNT | 0.5 | 2.4 | 1.2 |
| Example 4 | mixture | | | | | | | | |
| | layer | | | | | | | | |
| | second | | 83.1 | B1 | 15 | SWCNT | 0.1 | 0.6 | 1.2 |
| | mixture | | | | | | | | |
| | layer | | | | | | | | |
| Comparative | first | graphite | 89.9 | B2 | 6 | MWCNT | 0.5 | 2.4 | 1.2 |
| Example 5 | mixture | | | | | | | | |
| | layer | | | | | | | | |
| | second | | 83.1 | A1 | 15 | SWCNT | 0.1 | 0.6 | 1.2 |
| | mixture | | | | | | | | |
| | layer | | | | | | | | |
| Comparative | first | graphite | 89.9 | B1 | 6 | MWCNT | 0.5 | 2.4 | 1.2 |
| Example 6 | mixture | | | | | | | | |
| | layer | | | | | | | | |
| | second | | 83.1 | A1 | 15 | SWCNT | 0.1 | 0.6 | 1.2 |
| | mixture | | | | | | | | |
| | layer | | | | | | | | |

The prepared first negative electrode slurry was applied to a copper foil as a current collector, dried at 80° ° C. to form a first negative electrode mixture layer, and then a second negative electrode slurry was applied to the first negative electrode mixture layer and then dried at 80° ° C. to form a second negative electrode mixture layer to prepare a negative electrode.

### Evaluation of Battery Performance

A positive electrode was prepared by applying a slurry including an NCM-based active material, which is a lithium-transition metal composite oxide, to an aluminum foil and drying the same.

An electrode assembly was prepared by using the prepared positive electrode and each of the negative electrodes prepared in Example 1 and Comparative Examples 1 to 6 with a polyolefin separator interposed therebetween, the electrode assembly was placed in a pouch for a secondary battery, an electrolyte solution in which 1M LiPF₆ was dissolved was injected into a solvent mixed with ethylene carbonate (EC) and diethyl carbonate (DEC), and then sealed to manufacture a pouch-type lithium secondary battery.

For each pouch-type lithium secondary battery prepared above, room temperature and high temperature capacity retention rates and rapid charge capacity retention rates were evaluated, respectively, and the results are shown in Table 2. The evaluation method of each battery performance is as follows.

### (1) Room Temperature (25° C.) Capacity Retention Rate

For the secondary battery, evaluation of lifespan characteristics in the range of DOD94 (SOC4-98%) was performed in a chamber maintained at 25° C.

Under constant current/constant voltage (CC/CV) conditions, it was charged at 0.3 C to a voltage corresponding to SOC98%, then cut off at 0.05 C, then discharged at 0.3 C to a voltage corresponding to SOC4% under constant current (CC) conditions, and a discharge capacity thereof was measured.

After repeating this for 500 cycles, the capacity retention rate at the time of room temperature lifespan characteristic evaluation was measured by measuring a discharge capacity retention rate compared to an initial discharge capacity in %.

### (2) High Temperature (45° C.) Capacity Retention Rate

Regarding the secondary battery, the capacity retention rate at the time of high-temperature lifespan characteristic evaluation was measured by the same method as the room temperature (25° C.) lifespan characteristic evaluation in a chamber maintained at 45° C.

### (3) Rapid Charge Capacity Retention Rate

Regarding the secondary battery, it was charged to reach DOD72% within 35 minutes according to the following step charging method, and then discharged at 1/3 C.
Step charge=C-rate: 2.5C/2.25C/2.0C/1.75C/1.5C/1.25C/1.0C/0.75C/0.5C

300 cycles were repeated with charge/discharge set as one cycle and a waiting time of 10 minutes given between charge/discharge cycles, and then the rapid charge capacity retention rate was evaluated by measuring the discharge capacity retention rate compared to the initial discharge in %.

TABLE 2

| | Room temperature | high temperature | rapid charge |
|---|---|---|---|
| | capacity | capacity | capacity |
| | retention | retention | retention |
| | rate (%) | rate (%) | rate (%) |
| Example 1 | 95.1 | 88.3 | 97.5 |
| Comparative | 89.2 | 89.4 | 89.8 |
| Example 1 | | | |
| Comparative | 92.8 | 85.5 | 95.3 |
| Example 2 | | | |
| Comparative | 95.3 | 81.8 | 97.7 |
| Example 3 | | | |
| Comparative | 91.4 | 85.3 | 92.6 |
| Example 4 | | | |
| Comparative | 91.7 | 88.8 | 93.4 |
| Example 5 | | | |
| Comparative | 90.6 | 86.8 | 91.2 |
| Example 6 | | | |

Example 1 includes SiOx coated with carbon on the first negative electrode mixture layer as a negative electrode active material, and the SiOx is located in the lower layer despite a large fine powder content and may reduce side reactions with the electrolyte, thereby exhibiting excellent effect in terms of high-temperature capacity retention rate. Furthermore, the negative electrode of Example 1 includes SiOx doped with Mg in the second negative electrode mixture layer, which is the upper layer, and is controlled to include a small amount of fine powder, so that room temperature capacity retention rate and rapid charge capacity retention rate are excellent despite including a large amount of silicon-based active material. This is because contraction and expansion of the silicon-based negative electrode active material are suppressed by doping with Mg, thereby suppressing cracks and short circuits.

Comparative Example 1 shows excellent results in high-temperature capacity retention rate by including carbon-coated SiOx having a high fine powder content in the first negative electrode mixture layer, as in Example 1, but the second negative electrode mixture layer, which is an upper layer, includes carbon-coated SiOx with a reduced fine power content to degrade performance of suppressing contraction and expansion in the charging and discharging process, so that Comparative Example 1 was evaluated to exhibit the results of room temperature capacity retention rate and lower rapid charge capacity retention rate lower than those of Example 1.

Unlike Example 1, Comparative Example 2 is a case in which the first negative electrode mixture layer includes carbon-coated SiOx having a high fine powder content and the second negative electrode mixture layer, which is an upper layer, includes Mg-doped SiOx having a high fine powder content. Although contraction and expansion of the silicon-based negative active material may be suppressed by SiOx doped with Mg, the silicon-based active material with a large specific surface area including a large amount of fine powder has a low high-temperature capacity retention rate due to a side reaction with the electrolyte, and an effect of increasing a contact area between the negative electrode active materials and between the negative electrode active material and the negative electrode current collector in the lower layer, exhibiting the results of the room temperature and rapid charge capacity retention rates lower than those of Example 1.

Comparative Example 3 is a case in which both the first and second negative electrode mixture layers include Mg-doped SiOx, and as the contraction and expansion of the negative electrode active material during charging and discharging of the battery are suppressed to exhibit excellent results in room temperature and rapid charge capacity retention rates, but the high-temperature capacity retention rate was significantly reduced, which is considered to be caused by a side reaction between the silicon-based active material in the first negative electrode mixture layer and the electrolyte.

In addition, Comparative Example 4 shows low room temperature capacity retention rate and low rapid charge capacity retention rate. The silicon-based negative electrode active material is isolated due to contraction and expansion of the silicon-based negative electrode active material due to a small content of carbon-coated SiOx of fine powder in the first negative electrode mixture layer, which is the lower layer, thereby lowering the room temperature capacity retention rate and the lifespan characteristics.

In addition, Comparative Example 5 is a case in which the first negative electrode mixture layer includes Mg-doped SiOx having a high fine powder content and the second negative electrode mixture layer includes carbon-coated SiOx having a low fine powder content. Comparative Example 6 is a case in which the first negative electrode mixture layer includes Mg-doped SiOx having a low fine powder content and the second negative electrode mixture layer includes carbon-coated SiOx having a low fine powder content, and thus, the room temperature capacity retention rate and the rapid charge capacity retention rate were low due to contraction and expansion of the silicon-based negative electrode active material in the upper layer.

In an example embodiment of the disclosed technology, by including the silicon-based active material, the high-capacity negative electrode may be provided, and the lifespan characteristics of the negative electrode may be improved during rapid charging and discharging and at high temperatures.

In an example embodiment of the disclosed technology, side reactions between the silicon-based negative electrode active material and the electrolyte may be prevented, thereby suppressing an increase in resistance.

The disclosed technology can be implemented in rechargeable secondary batteries that are widely used in battery-powered devices or systems, including, e.g., digital cameras, mobile phones, notebook computers, hybrid vehicles, electric vehicles, uninterruptible power supplies, battery storage power stations, and others including battery power storage for solar panels, wind power generators and other green tech power generators. Specifically, the disclosed technology can be implemented in some embodiments to provide improved electrochemical devices such as a battery used in various power sources and power supplies, thereby mitigating climate changes in connection with uses of power sources and power supplies. Lithium secondary batteries based on the disclosed technology can be used to address various adverse effects such as air pollution and greenhouse emissions by powering electric vehicles (EVs) as alternatives to vehicles using fossil fuel-based engines and by providing battery-based energy storage systems (ESSs) to store renewable energy such as solar power and wind power.

Only specific examples of implementations of certain exemplary embodiments are described. Variations, improvements and enhancements of the disclosed embodiments and other embodiments may be made based on the disclosure of this patent document.

What is claimed is:

1. A negative electrode for a secondary battery, the negative electrode comprising:
a negative electrode current collector;
a first negative electrode mixture layer including a first silicon-based negative electrode active material and disposed on at least one surface of the negative electrode current collector; and
a second negative electrode mixture layer including a second silicon-based negative electrode active material and disposed on the first negative electrode mixture layer,
wherein the second silicon-based negative electrode active material is SiOx doped with a metal element, wherein x is greater than or equal to 0 and less than 2.

2. The negative electrode of claim 1, wherein the metal element is at least one of Mg, Li, Ca, Al, Fe, Ti, or V.

3. The negative electrode of claim 1, wherein a content of the second silicon-based negative electrode active material having a particle size of 2.5 μm or less is less than 5 volume % of a total content of the second silicon-based negative electrode active material.

4. The negative electrode of claim 1, wherein the first silicon-based negative electrode active material is SiOx coated with carbon.

5. The negative electrode of claim 1, wherein a content of the first silicon-based negative electrode active material having a particle size of 2.5 μm or less is 1 volume % or more and less than 15 volume % of a total content of the first silicon-based negative electrode active material.

6. The negative electrode of claim 1, wherein a content of the second silicon-based negative electrode active material is greater than a content of the first silicon-based negative electrode active material with respect to a total weight of the first negative electrode mixture layer and the second negative electrode mixture layer.

7. The negative electrode of claim 6, wherein a content of the first silicon-based negative electrode active material in the first negative electrode mixture layer is 2 to 6 wt %.

8. The negative electrode of claim 6, wherein a content of the second silicon-based negative electrode active material in the second negative electrode mixture layer is 7 to 30 wt %.

9. The negative electrode of claim 1, wherein the first negative electrode mixture layer and the second negative electrode mixture layer further include a graphite-based active material.

10. The negative electrode of claim 1, wherein the first negative electrode mixture layer and the second negative electrode mixture layer further include a conductive agent.

11. The negative electrode of claim 10, wherein the second negative electrode mixture layer includes, as a conductive agent, at least one of single-walled carbon nanotube (SWCNT), thin-walled carbon nanotube (TWCNT), or multi-walled carbon nanotube (MWCNT).

12. A lithium secondary battery comprising:
a negative electrode, a positive electrode, and a separator interposed between the negative electrode and the positive electrode,
wherein the negative electrode comprises:
a negative electrode current collector;
a first negative electrode mixture layer including a first silicon-based negative electrode active material and disposed on at least one surface of the negative electrode current collector; and
a second negative electrode mixture layer including a second silicon-based negative electrode active material and disposed on the first negative electrode mixture layer,
wherein the second silicon-based negative electrode active material is SiOx doped with a metal element, wherein x is greater than or equal to 0 and less than 2.

13. The lithium secondary battery of claim 12, wherein the metal element is at least one of Mg, Li, Ca, Al, Fe, Ti, or V.

14. The lithium secondary battery of claim 12, wherein a content of the second silicon-based negative electrode active material having a particle size of 2.5 μm or less is less than 5 volume % of a total content of the second silicon-based negative electrode active material.

15. The lithium secondary battery of claim 12, wherein the first silicon-based negative electrode active material is SiOx coated with carbon.

16. The lithium secondary battery of claim 12, wherein a content of the first silicon-based negative electrode active material having a particle size of 2.5 μm or less is 1 volume % or more and less than 15 volume % of a total content of the first silicon-based negative electrode active material.

17. The lithium secondary battery of claim 12, wherein a content of the second silicon-based negative electrode active material is greater than a content of the first silicon-based negative electrode active material with respect to a total weight of the first negative electrode mixture layer and the second negative electrode mixture layer.

18. The lithium secondary battery of claim 17, wherein a content of the first silicon-based negative electrode active material in the first negative electrode mixture layer is 2 to 6 wt %.

19. The lithium secondary battery of claim 17, wherein a content of the second silicon-based negative electrode active material in the second negative electrode mixture layer is 7 to 30 wt %.

20. The lithium secondary battery of claim 12, wherein the first negative electrode mixture layer and the second negative electrode mixture layer further include at least one of a graphite-based active material or a conductive agent.
